(19) United States
(12) Patent Application Publication
(10) Pub. No.: US 2025/0327556 A1
(43) Pub. Date: Oct. 23, 2025

(54) WIRELESS LIGHTING DEVICE WITH EXTENDED DURATION ILLUMINATION

(71) Applicant: Zealio Electronics Co., Ltd., HsinChu City (TW)

(72) Inventors: Paul Guo, HsinChu City (TW); Toye Teng, HsinChu City (TW); Chia-Pao Cheng, HsinChu City (TW)

(73) Assignee: Zealio Electronics Co., Ltd., HsinChu City (TW)

(21) Appl. No.: 18/641,793

(22) Filed: Apr. 22, 2024

(51) Int. Cl. F21S 43/16; F21S 43/30; F21V 23/04; F21Y 115/10

(52) U.S. Cl. CPC F21S 43/16; F21S 9/02; F21S 43/30; F21V 23/0435; F21Y 2115/10

(57) ABSTRACT

A wireless lighting device for vehicle accessories includes a signal transmitter and an encapsulated light board. The light board includes a unitary baseplate, a backlight module, a power module, and a top cover. The backlight module includes a circuit board, light emitting elements, a transceiver, and a control module configured to turn the light emitting elements on and off according to the detected signal. The power module includes a battery and a conductive strip configured to electrically connect the battery to the circuit board. The top cover configured to be irreversibly sealed to the baseplate with a customizable light permeable region with a phosphorescent dispersion covering the light elements. The transmitter configured to be installed on surfaces of a vehicle, and the light board configured to be installed in a vehicle accessory. The wireless lighting device has at least a ten-year operational life without replacement of the batteries therein.

### FIELD OF THE INVENTION

The present invention relates in general to a wireless light panel, and in particular to a battery powered wireless light panel with enhanced and extended duration illumination for a vehicle.

### BACKGROUND OF THE INVENTION

In modern society, vehicles are widely used as tools for people to travel and to transport goods. Many vehicles have lighting devices that are used as decorative effects and also to provide daytime and nighttime warning and safety effects. Many of such lighting devices are provided on the vehicle as originally manufactured, installed by manufacturers as standard features of a vehicle or as special add on features specially selected and paid for by consumers. Additionally, some lighting effects may be installed by consumers as “aftermarket” add-ons.

For example, lighting devices may be provided on vehicle doors, trunk lids, liftgates, within vehicle storage areas, floor mats, seats, and other portions of vehicle exteriors or interiors. Lighting devices provided on vehicle doors may serve as warning and safety lights, so that when the door opens the lighting device illuminates to provide a visual warning to rear approaching cars and pedestrians, alerting them to the open door so that collisions can be avoided. Vehicle door lighting devices may also serve as “welcome” lights, so that when the door opens, the lighting device is illuminated to enhance visibility as a driver or passenger enters or exits the vehicle. Additionally, lighting devices provided on a vehicle exterior, such as in the vehicle doors, hood, trunk, rear liftgate, etc. and/or on a vehicle or interior, such as in floor mats, seats, dashboard, steering wheel, footwells, etc. may also be provided to illuminate upon locking or unlocking of the vehicle or upon opening of the vehicle door to enhance visibility or to show some decorative effect such as a brand name or logo.

While such lighting devices are currently available on the market, conventional devices have several limitations. First, many lighting devices are hardwired into a vehicle and as a result have met with limited market acceptance since such devices require electrical harnesses to connect with the vehicle power supply. Electrical harnesses are themselves expensive and complex and this is compounded by the difficulty and expense of wiring into the vehicle. Thus, a consumer is confronted with a professional wiring expense or the complexity of attempting themselves. Furthermore, such hard-wired lighting devices can easily short circuit, thereby failing to function as intended while also potentially impeding the functionality of other components that are provided on the same circuit. Additionally, such hard-wired lighting devices place additional electrical load on the vehicle's power supply, potentially draining the vehicle's battery if the lighting device malfunctions in some way. Aftermarket hardwiring can also void vehicle warranties.

Other existing lighting devices are provided with batteries as an on-unit power source. While avoiding some of the problems associated with hard wired lighting devices, existing battery powered lighting devices present a separate set of problems. For example, the batteries on such lighting devices have short lifespans that typically last about one year of expected usage, or two years at most. Such existing battery-operated lighting devices are thus configured so that the battery compartments thereof are accessible to the vehicle owner so that the spent batteries can be replaced. The purchase of replacement batteries can add considerably to the cost of operation of the lighting device of time, requires the user to stock replacement batteries, have knowledge the replacement process; and invariably leads to intermittent failures of the lighting device that subject the user to the safety features, enhanced visibility, aesthetics, and brand awareness the lighting device was intended to provide. In order to avoid the need to replace the batteries, the batteries may be rechargeable batteries.

Regardless of the type of battery, an accessible battery compartment or charging port are vulnerable to environmental exposures such as humidity, moisture from precipitation, and extreme temperatures which can damage the lighting device, thereyby destroying the intended functionality thereof. Lighting devices positioned in floor mats, vehicle doors, and vehicle exteriors, are exposed to climate specific stressors such as temperature extremes, humidity, and even corrosive salts used to melt snow; all of which can damage batteries.

Thus, there exists a need for a lighting device for vehicles that provides at least the attributes of a safety feature, enhanced visibility, aesthetics, or brand awareness that overcomes the problems associated with existing hard wired lighting devices and battery-operated lighting devices, instead providing a long-lasting operational life and easy installation by manufacturers or aftermarket consumers. There further exists a need to limit potential damage and failure caused by short circuits, user errors, or environmental factors.

### SUMMARY OF THE INVENTION

The present invention provides a wireless lighting device for vehicle accessories that includes a baseplate, a light-emitting backlight module, a power module, and a top cover. The baseplate defines at least one recess therein. The light-emitting backlight module includes a circuit board, a plurality of light emitting elements, a sensor, a transceiver configured to detect the signal transmitted by the transmitter, and a control module configured to turn the light emitting elements on and off according to the signal detected by the transmitter. The light-emitting backlight module is configured to be accommodated within the recess of the baseplate. The power module includes at least one battery and a conductive strip, the conductive strip extending from an end of the circuit board and configured to electrically connect the at least one battery to the circuit board and provides power to the sensor, transmitter, and the light-emitting backlight module. In some instances, the power module retains enough electrical storage for 10 years of vehicle usage without opening the light board. The top cover has at least one light permeable region, the top cover configured to cover the light-emitting backlight module and the power module and to be irreversibly sealed to the baseplate to complete the encapsulant.

At least one light permeable region has an optical structure for concentrating and projecting the light scattered by the plurality of light-emitting elements to enhance the illumination intensity. The top cover has at least one phosphorescent material in the light-emitting area, the phosphorescent material light-emitting area supplements the luminous energy emitted from the plurality of light-emitting elements of the wireless lighting device by absorbing the light emitted by the plurality of light-emitting elements and the ambient light outside the device that then provides afterglow phosphorescence. The afterglow material provides illumination when the active plurality of light-emitting elements is turned off. In addition to providing phosphorescence and an extended lighting effect, the phosphorescent material in the light-emitting area also enhances the lighting intensity of the light-emitting elements when activated.

A transmitter can be provided that is configured to be installed on a door or a frame of a vehicle to remotely activate the wireless lighting device. The wireless light device is configured to be installed in a vehicle trunk, rear liftgate, a vehicle door, vehicle seat, a vehicle floor mat, or other vehicle surface areas. Advantageously, the wireless lighting device has at least a ten-year operational life without replacement of the batteries therein and can still emit light through resort to the electrically passive phosphorescent material.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an exploded perspective view of a wireless light board of a wireless lighting device according to embodiments of the present invention;

FIG. 2 is a schematic showing the elements of a circuit board of a wireless light board according to embodiments of the present invention;

FIG. 3A is a top view of a light board of a wireless lighting device according to embodiments of the present invention;

FIG. 3B is a side view of the light board of FIG. 3A;

FIG. 3C is an end view of the light board of FIGS. 3A and 3B;

FIG. 4A is a cross sectional view of the light board of FIG. 3A taken along line A-A;

FIG. 4B is a detailed cross-sectional view of the portion B indicated in FIG. 4A;

FIG. 5A is a front view of a transmitter unit of a wireless lighting device according to embodiments of the present invention;

FIG. 5B is a side view of the transmitter unit of FIG. 5A;

FIG. 6 is a perspective view of an embodiment of a light board of the present invention being installed on a vehicle seat;

FIG. 7 is a perspective view of an exploded view of an embodiment of a light board of the present invention being installed on a vehicle seat;

FIG. 8 is a perspective view of a light board embedded within a vehicle floor mat according to embodiments of the present invention;

FIG. 9 is a view of a portion of a vehicle having an inventive wireless lighting device installed therein according to embodiments of the present invention;

FIG. 10 is an end view of a vehicle door having a light board installed thereon according to embodiments of the present invention;

FIG. 11 is an exploded perspective view of a wireless light board of a wireless lighting device according to embodiments of the present invention;

FIG. 12 is an exploded perspective view of a wireless light board of a wireless lighting device according to embodiments of the present invention;

FIG. 13 is a rear view of a vehicle having a wireless lighting device mounted on a liftgate thereof according to embodiments of the present invention;

FIG. 14A is a rear view of a vehicle having a transmitter unit device with a sensor configured for measurement of inclination mounted on a liftgate thereof according to embodiments of the present invention;

FIG. 14B is a rear view of the vehicle of FIG. 14A having a wireless lighting device in communication with the transmitter unit device of FIG. 14A, the wireless lighting device mounted to the interior of the vehicle in proximity to the liftgate thereof according to embodiments of the present invention;

FIG. 15A is a side view of the vehicle of FIG. 14A with the liftgate moving toward an open position with an angle of inclination greater than an open threshold required to transmit a signal to turn on the wireless lighting device of FIG. 14B in accordance with embodiments of the invention;

FIG. 15B is a side view of the vehicle of FIG. 14A with the liftgate moving toward a closed position with an angle of inclination less than a closed threshold required to transmit a signal to turn off the wireless lighting device of FIG. 14B in accordance with embodiments of the invention;

FIG. 16 is a flow diagram of commands representative of software that control operation of the transmitter unit device of FIG. 14A in accordance with embodiments of the invention;

FIG. 17 is a flow diagram of commands representative of software that control operation of the wireless lighting device of FIG. 14B in accordance with embodiments of the invention;

FIGS. 18A-18C are a top view, front view, and right side view, respectively, of the wireless lighting device of FIG. 14B in accordance with embodiments of the invention;

FIG. 19 is a perspective front view of the wireless lighting device of FIG. 14B in accordance with embodiments of the invention;

FIG. 20 is an exploded view of the wireless lighting device of FIG. 14B in accordance with embodiments of the invention;

FIG. 21 is a partial cutaway view of the top cover of the light permeable region with a sandwich structure with a top glass layer that encapsulates a dispersion of phosphorescent material applied to an upper surface of a bottom glass layer according to embodiments of the present invention; and

FIG. 22 is a perspective view of an optical lampshade with a parabolic surface with either a mirrored or white surface according to embodiments of the present invention.

### DESCRIPTION OF THE INVENTION

The present invention has utility as a wireless lighting device for vehicles that provides safety features, enhanced visibility, aesthetics, and brand awareness that provides a long-lasting operational life and easy installation by manufacturers or aftermarket, while also avoiding potential damage and failure caused by short circuits, user errors, or environmental factors.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

According to embodiments, the present invention provides a wireless lighting device for vehicle accessories whose novel design provides compactness, easy installation, long operational life without battery changes, high power efficiency, and encapsulation to protect the device from environmental effects and from human interference. The inventive wireless lighting device is configured to use in vehicle exteriors and/or vehicle interiors including hoods, trunks, liftgates, doors, seats, dashboards, seats, steering wheels, floormats, and other suitable components.

Embodiments of an inventive wireless lighting device includes a housing that includes a base plate and a top cover with at least one light-transmitting area. The top cover further has at least one luminous area treated with a phosphorescent material, to define an encapsulant and an interior volume therein. A light-emitting module configured to be received in the internal volume of the housing. The light-emitting module includes a circuit board, a plurality of light-emitting elements, a sensor configured to detect a signal, and a control module configured to turn on and off the plurality of light-emitting elements according to a detected signal. The wireless lighting device further includes a power module including at least one battery and a conductive strip extending from one end of the circuit board for electrically connecting the at least one battery to the circuit board and for the sensor.

In some inventive embodiments of the wireless lighting device the sensor illustratively includes a magnetic sensor or a gravity or accelerometer sensor, as well as a transmitter configured to transmit a signal that can be detected by the sensor. In specific embodiments, the light-emitting module may have at least one of a proximity sensor or an ambient light sensor to conserve power by limiting light output to when actually required. In specific embodiments the transmitter is installed on the frame of a vehicle or on a door, trunk lid, or liftgate, and the transmitter is disposed within a transmitter unit having a housing. In a specific embodiment, the signal emitted by the transmitter is a radio frequency signal. The top cover in some embodiments is configured to be non-reversible sealed to the base plate. The sensor and the backlight module provide power in some inventive embodiments afford an extended period of time of up to ten years without replacing the battery.

In specific embodiments of the inventive wireless lighting device the phosphorescent is dispersed on the top cover and has an excitation energy that is less than emission wavelength of the light source. The phosphor is selectively excited only where exposed to a source of light. This spatially resolved phosphorescence induces a phosphorescent glow that is discernable under low ambient light conditions. As used herein, the term “low ambient light” is defined to mean an illumination of less than one Candle. Preferably, the light source is a light emitting diode (LED). LEDs operative herein include those emitting in the ultra-violet (UV) spectrum of 280 nm to 400 nm and the visible light spectrum of 400 nm to 700 nm. It is appreciated that the light source emission wavelength need only be greater than the excitation energy of a phosphor being impinged upon. A visible light spectrum light source is appreciated to provide energized emissions that are detected by a normal, unaided human eye that can also function to excite a phosphorescent material. In still other embodiments, a mix of visible and UV emitting light sources are present in an inventive device.

In specific embodiments of the inventive wireless lighting device the dispersion of phosphorescent material are phosphorescent inorganic particles or organic phosphorescent molecules. Inorganic phosphorescent particulate operative herein illustratively includes sulfides, selenides, oxides, phosphates and sulfates of alkaline earths, zinc, main group metals, and lanthanide doped forms thereof as exemplified in U.S. Pat. Nos. 2,372,071; 2,979,467; 4,725,324; 4,725,344; 4,857,228; and 6,005,024. A typical inorganic phosphorescent particle used herein has a domain size of between 0.3 and 100 microns. Organic luminescent molecules illustratively include coumarin, azo, cyanine, and quinoline dyes. The phosphorescent dispersion is applied in some inventive embodiments with a polymeric binder or adhesive to the top cover.

The top cover of an inventive device may be made of optical transparent sheet materials that illustratively include acrylics, silicate glass, and quartz glass. In some inventive embodiments, the surface of the top cover to which phosphorescent dispersion is applied is polished to a reflective surface. A reflective substrate surface serves to reflect ambient light penetrating the phosphorescent dispersion back therethrough providing a second opportunity for the excitation thereof. The phosphorescent dispersion forms a surface on the top cover by methods illustratively including applying a topcoat of phosphorescent material to the top cover substrate, molding a polymeric sheet having phosphorescent material embedded therein.

In specific inventive embodiments, the top cover includes a parabolic surface with either a mirrored or white coating that provides enhanced reflectivity compared to non-parabolic surfaces and parabolic surfaces lacking an aforementioned coating.

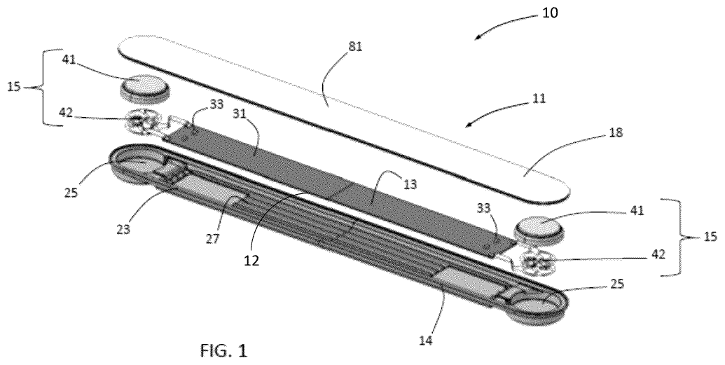

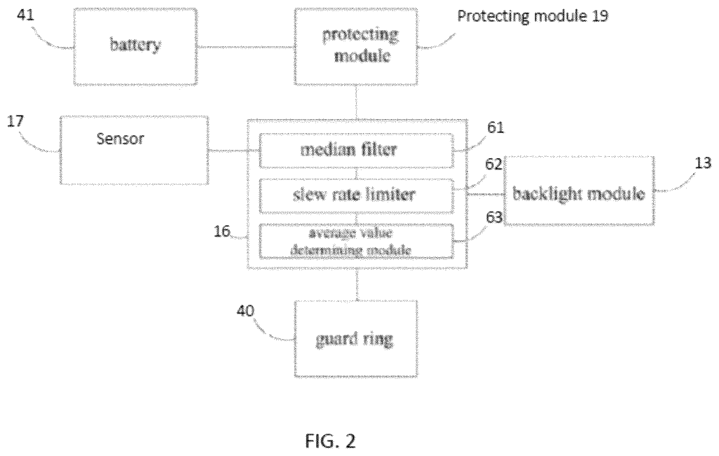

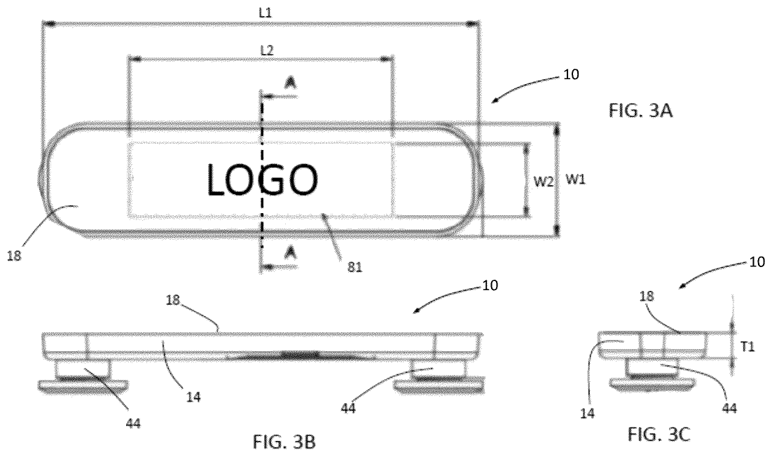

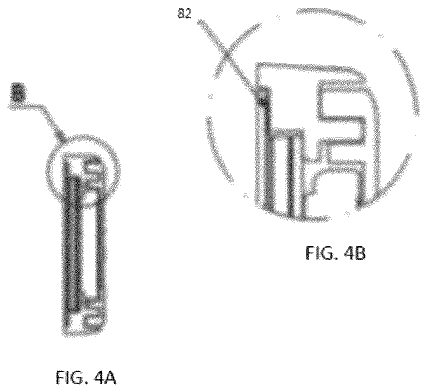

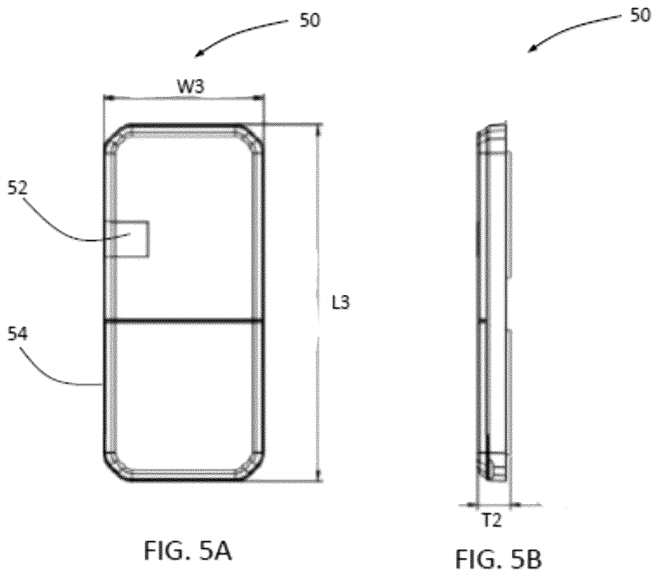

Referring to FIGS. 1, 11, 12, and 14B, 18A-18C, 19, 20, and 21, embodiments of an inventive wireless lighting device are shown generally at 10 and 10′, respectively. FIGS. 1, 11, and 12 show exploded perspective views of the lighting device 10 according to specific embodiments of the present invention. The wireless light device 10 includes a housing 11 that includes a baseplate 14, 14′, 14″, a backlight module 13, a power module 15, a sensor 17, a control module 16 (shown in FIG. 2), a sealed top cover 18, 18′, 18″, and an optional protecting module 19. The top cover 18, 18′, 18″ is configured to be irreversibly sealed to the baseplate 14. 14′, 14″ to define an encapsulant and an internal volume therein. The backlight module 13, power module 15, sensor 17, control module, 16, and optional protecting module 19 are configured to be positioned within the internal volume of the housing 11 and sealed therein. FIG. 2 is a block diagram schematically showing the system of a wireless lighting device 10 according to embodiments of the present invention. The detailed structure thereof is described below.

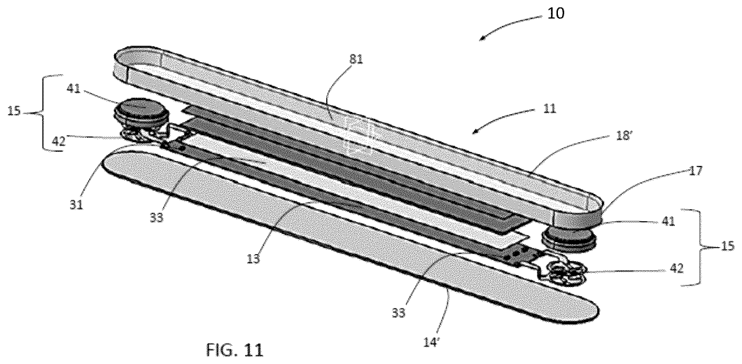

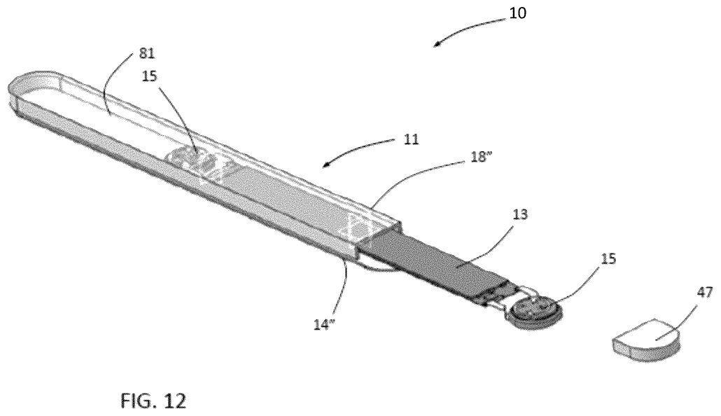

As shown in FIG. 1, the baseplate 14, according to inventive embodiments, has an upper surface and a lower surface opposite to the upper surface, wherein the upper surface has a main recess 23 and at least one battery recess 25 formed in at least one end of the main recess 23. According to some inventive embodiments, the main recess 23 is provided between two battery recesses 25. According to still other inventive embodiments, the main recess 23 has a plurality of ridges 27 formed therein, which provide a platform for the backlight module 13 and allow for air gaps between the various components of the light board 12. As shown in FIG. 11, the baseplate 14′, according to inventive embodiments, is a planar component configured to be sealed with a top cover 18′ that includes walls 17. As shown in FIG. 12, housing 11, according to inventive embodiments, includes a baseplate 14″ and a top cover 18″ that are joined or formed together as a tube into which the backlight module 13 may be slid. According to inventive embodiments, a cap 47 is additionally provided as part of the housing 11. The cap 47 is configured to be irreversibly sealed to the baseplate 14″ and the top cover 18″.

According to inventive embodiments, the baseplate 14, 14′, 14″ is formed of a plastic or metal material. According to still other inventive embodiments, the baseplate 14, 14′, 14″ is integrally formed as a single unitary body.

The backlight module 13 of the light board 12 is accommodated by the baseplate 14 and includes a circuit board 31. According to some inventive embodiments, the circuit board 31 is accommodated within the main recess 23 or the baseplate 14. According to other inventive embodiments, the backlight module 13 includes a plurality of light-emitting elements 33. The light-emitting elements 33 may be but are not limited to edge-lit LEDs. According to still other inventive embodiments, the light-emitting elements 33 are positioned at the two ends of the circuit board 31, however, they may be provided in any position or pattern on the circuit board 31. According to still other inventive embodiments, the backlight module 13 additionally includes a light-guide plate (not shown) arranged above the circuit board 31 to distribute the light of the light-emitting elements 33 uniformly. It can be understood that a plurality of dot patterns is utilized to form inside the light-guide plate to effectively diffuse light. According to still other inventive embodiments, the circuit board 31 includes an anti-electromagnetic interference structure which is formed by net copper layout.

According to some inventive embodiments, the power module 15 includes at least one battery 41 and at least one conductive strip 42, wherein at least one battery 41 is positioned inside the battery recess 25 and the conductive strip 42 electrically connects to the battery 41 and the circuit board 31. According to other inventive embodiments, the conductive strip 42 is also positioned in the battery recesses 25. As shown in FIG. 1, a conductive strip 42 is provided at each of the ends of the circuit board 31 and the conductive strips 42 are configured to be accommodated within the battery recesses 25 at the ends of the baseplate 14. As shown in the still other inventive embodiment of FIG. 1, there are two batteries 41, each being configured to be positioned in a battery recess 25 at the ends of the baseplate 14 with a conductive strip 42 of the backlight module 13 to electrically connect each battery 41 to the circuit board. According to still other inventive embodiments, the batteries 41 of the light board 12 are each CR2450 batteries, each having a capacity of 620 mAH. According to still other inventive embodiments, the power consumption of the light board 12 is 8-10 mA when the light board 12 is on and is 1-20 uA when the light board 12 is on standby. According to still other inventive embodiments, the batteries 41 of the light board 12 are designed to provide up to ten years of operational life.

According to some inventive embodiments, the circuit board 31 has a sensor 17 electrically coupled thereto. According to some inventive embodiments, the sensor 17 is a magnetic sensor as described in U.S. Pat. No. 10,883,856, which was issued on Jan. 5, 2021. According to such embodiments as best shown in FIG. 9, the light board is provided in a vehicle door, vehicle door frame or sill, or in the vehicle interior and the interaction of the sensor 17 and the vehicle door 76 or vehicle frame 75 results in the on/off operation of the wireless light board 12 of the inventive wireless lighting device 10. When the wireless lighting device 10 of the present invention is applied to a vehicle, such as with the light board 12 provided on a vehicle exterior, door, or door sill component and the opening or closing of the door 76 causes differences in the magnetic strength received by the sensor 17 due to the proximity or separation of the door 76. For example, when the door 76 is opened away from the vehicle V frame 75 or closed, the sensor 17 detects different magnetic values for the control module 16 to turn on or off the backlight module 13 accordingly.

According to some inventive embodiments, the sensor 17 is a radio frequency transceiver, such as a 2.4 GHz radio frequency transceiver chip. According to other inventive embodiments, the transceiver works in conjunction with a wireless system-on-chip (SOC) processor. According to embodiments, in which the sensor 17 is a transceiver is configured to detect radio frequency emitted by a separately provided radio frequency transmitter 52 provided in a transmitter unit 50. The transmitter unit 50 is configured to transmit a wireless radio frequency signal to the sensor in the form of the radio frequency transceiver 17 in the light board. The interaction of the transmitter unit 50 and the transceiver 17 results in the light board 12 turning on and off, controlled by a control module 16. Further details of the components making up the inventive wireless lighting device 10 are described herein. The interaction of the transceiver 17 and the transmitter 52, results in the on/off operation of the wireless light board 12 of the inventive wireless lighting device 10. When the wireless lighting device 10 of the present invention is applied to a vehicle, such as with the light board 12 provided on a vehicle exterior or interior component and the transmitter unit 50 provided for example on the vehicle door 76 as shown in FIG. 9, the opening or closing of the door 76 causes differences in the radio frequency received by the transceiver 17 due to the proximity or separation of the door 76. For example, when the door 76 is opened away from the vehicle V frame 75 or closed, the transceiver detects different radio frequency values for the control module 16 to turn on or off the backlight module 13 accordingly.

The control module 16 is arranged on the circuit board 31 and electrically connected with the backlight module 13 and the sensor 17. The control module 16 turns on/off the backlight module 13 according to the signal sensed by the sensor 17. In one inventive embodiment, the backlight module 13 is on neither normally-on nor normally off status. The control module 16 can intelligently adjust the time interval of the turn-on or turn-off state according to the received signal. In this inventive embodiment, the protecting module 19 is connected to the battery 41 and the control module 16. The protecting module 19 protects the control module 16 from short circuits caused by inverse mounting of the battery 41, though according to inventive embodiments, the protecting module 19 may be omitted given that the encapsulated nature of the inventive wireless lighting device 10 prevents a user from changing the batteries 41 thereof, thereby reducing the risk of the batteries 41 being inversely mounted. According to some inventive embodiments, the control module 16 further includes a median filter 61 and a slew rate limiter 62 configured to receive the radio frequency signal from the transceiver 17 and filter noises of the received signal. The control module 16 further includes an average value determining module 63 configured to receive the noise-filtered signal and shift the average value of the signal by comparison of the noise-filtered signal with a previously determined average value of the signal. When the noise-filtered signal is larger than the previously determined average value, the average value is added by a preset value, such as 1. When the noise-filtered signal is smaller than the previously determined average value, the average value is subtracted by a preset value, such as 1. Since the average value may depend on some environmental factors, such as temperature or humidity, the shifting of the average value provides control precision in consideration of the environmental factors. In this inventive embodiment, a guard ring 40 is formed on the circuit board 31 to prevent current leakage.

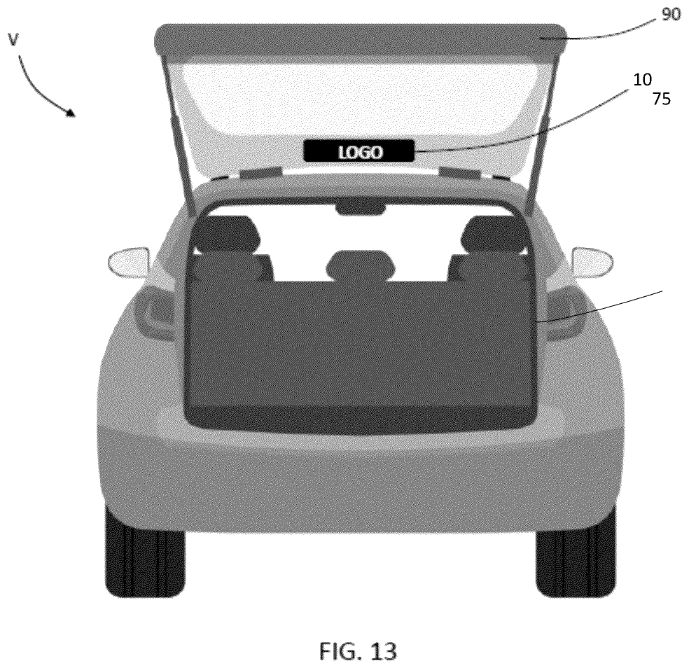

According to some inventive embodiments, the sensor 17 is a gravity sensor. According to embodiments, the gravity sensor measures the direction and intensity of gravity. Using such data, the relative direction of the device within a space is determined from which a degree of inclination may be determined. Alternatively, sensor 17 may be an accelerometer configured to measure inclination. FIG. 13 shows a rear view of a vehicle V having a liftgate 90 shown in an open position. On an interior side of the liftgate 90, a wireless light board device 10 is provided. According to embodiments, the gravity sensor within the light board 12 senses the gravitational change when the liftgate is moved from a closed position to an open position, as shown, whereby the control module 16 turns the light-emitting elements 33 of the wireless light board 12 on, such that a logo provided thereon is illuminated. Upon closing the liftgate, the sensor 17 again senses this gravitational change, thereby causing the light-emitting elements 33 of the wireless light board 12 to be turned off so that the light board 12 is not illuminated when the liftgate 90 is in a closed position. According to further embodiments, the light-emitting elements 33 are configured to turn on when the liftgate 90 is closed and off when the liftgate 90 is open. According to further embodiments, the wireless light board 12 is provided on an exterior side of the liftgate 90. It is appreciated that light board device 10 fitted to a trunk lid on a vehicle would operate in a similar manner to that of a liftgate 90 as described above.

In the present invention, the overall thickness T1 of the wireless light board device 10 is controlled to be within 3-10 mm to meet the requirement of slimness and compactness. According to some inventive embodiments, the overall length L1 of the wireless light board device 10 is 50-200 mm long, while the overall width W1 of the wireless light board device 10 is 20-50 mm wide. According to some inventive embodiments, the light permeable region 81 of the top cover has a length L2 that is anywhere from 10-90% of the length of the wireless light board device 10 and a width W2 that is anywhere from 10-90% of the width of the wireless light board device 10.

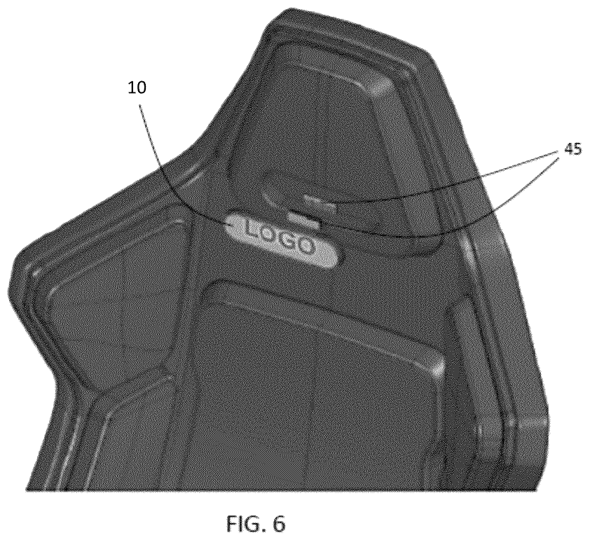

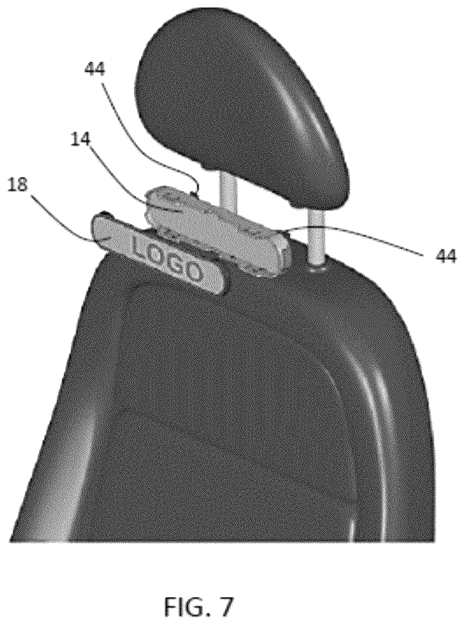

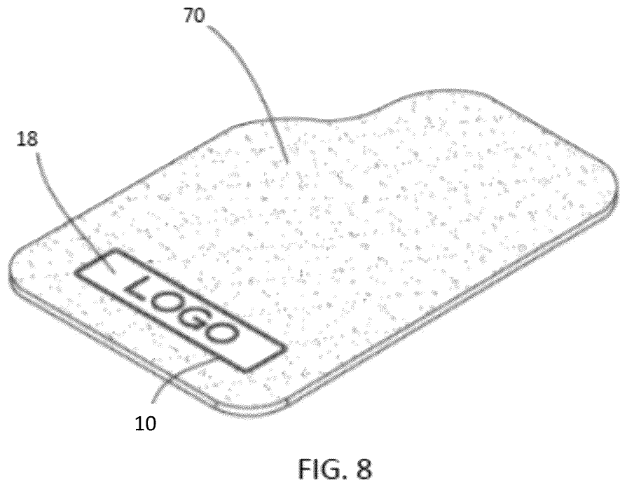

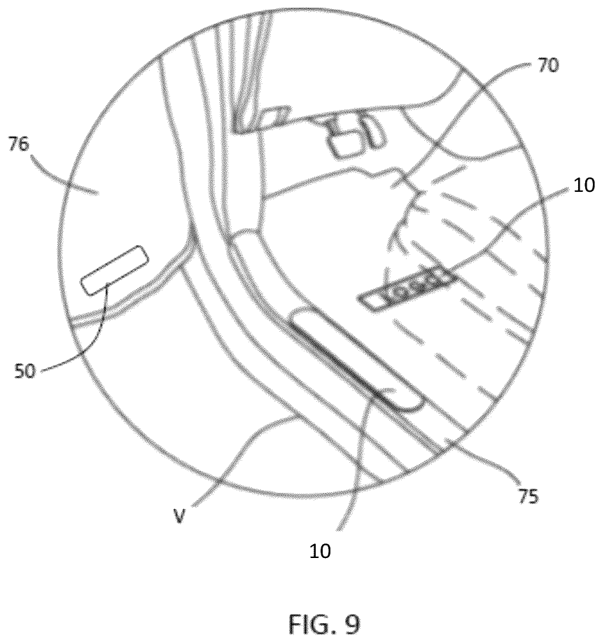

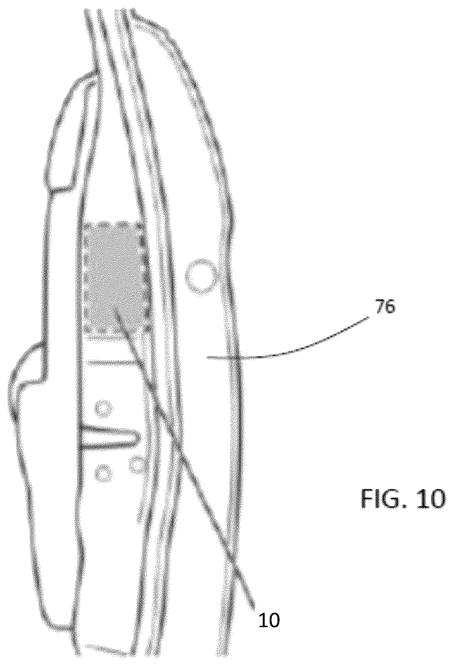

According to some inventive embodiments, the wireless light board device 10 includes at least one attachment bracket 44 that is formed with or attached to the second surface of the baseplate 14, 14′, 14″. According to still other inventive embodiments, the at least one bracket 44 is adjustable. As shown in FIG. 7, the wireless light board device 10 includes two adjustable brackets 44 which are configured to clip to a vehicle component such as a seat headrest as shown. According to still other inventive embodiments, the wireless light board device 10 is configured to attach to a vehicle component by way of a double-sided adhesive tape or hook and loop fastener 45, as shown in FIG. 6. According to still other inventive embodiments, the inventive wireless light board device 10 is embedded in a vehicle component, given that the batteries 41 are specifically designed to provide a long operation life for the light board device 10 and are intended to not ever be removed or replaced. FIG. 8 shows a light board device 10 embedded within a floor mat 70 vehicle component.

As noted above, some inventive embodiments of the inventive wireless lighting device 10 additionally include a transmitter unit 50 that includes a transmitter 52 powered by a battery (not shown) all enclosed within a housing 54. According to still other inventive embodiments, the transmitter 52 is a radio frequency transmitter, such as a 2.4 G radio frequency transmitter chip. According to still other inventive embodiments, the battery that powers the transmitter unit 50 is a button battery, such as a TS-SDI: CR2430 or CR2450. Like the wireless light board device 10, the transmitter unit 50 is fully encapsulated such that it is not intended to be opened for battery removal or replacement. The encapsulation protects the transmitter unit 50 from environmental effects such as humidity and moisture while also protecting from human interference. The encapsulation of the transmitter unit 50 helps ensure that the operational life of the battery is long. According to some inventive embodiments, the transmitter unit 50 is very compact, being 50-100 mm in length L3, 30-50 mm in width W3, and 3-10 mm thick T2. Like the light board device 10, the transmitter unit 50 is wireless and may be installed by a manufacturer or as an aftermarket add on. According to still other inventive embodiments, the transmitter unit 50 is configured to be applied to a vehicle door by double-sided adhesive tape, by s hook and loop fastener, by a clip, or the unit 50 may be embedded in the vehicle door, for example provided in the space between the vehicle exterior panel and the vehicle interior panel. According to still other inventive embodiments, the transmitter unit 50 includes a wireless SOC processor. According to still other inventive embodiments, the transmitter unit has a low power consumption, as it uses only 6-8 mA when active and only 1-5 uA when the transmitter unit is on standby. According to some embodiments the transmitter unit has an operational life of up to two years, but may then subsequently be replaced by a replacement transmitter unit 50. According to such embodiments, the transmitter unit 50 is configured such that the battery of the transmitter unit 50 may be replaced by a user to extend the operational life of the transmitter unit to be similar to the long operational life of the encapsulated light board 12. According to still other inventive embodiments, the transmitter unit has an operational life of up to ten years depending on the batteries that are provided therein.

In some inventive embodiments, the components of the inventive lighting device 10 have a long operational life so that the batteries do not need to be removed or replaced. According to some inventive embodiments, the batteries 41 of the light board device 10 are CR2450 batteries, which have a capacity of 620 mAH. Given that two of such batteries 41 are provided in the light board device 10, the light board 12 is accordingly provided with a capacity of 1240 mAH. The self-discharge rate of each battery is 1% per year, so in order to keep 10 years battery life the remaining battery capacity is 90% remaining, based on 620×2×90%=1160 mAH (10 years discharge=1%×10 years=10%). The inventive lighting device 10 may sit in storage from factory to install in car for about 1 year (1 uA/h×24×365 days=8.76 mAH). Accordingly, to calculate the battery life, one must deduct the self-discharge and the storage. Accordingly, the capacity required to operate the inventive light board 12 for ten years is 1240×90%-8.76=1106 mAH, which is well below the total battery capacity provided by the two batteries 41 of the wireless light board 12. Accordingly, the inventive wireless light board device 10 has at least a ten-year operational life without needing to have the batteries removed or replaced.

Similarly, the capacity required to operate the inventive transmitter unit 50 with its one CR2450 battery, which has a capacity of 620 mAH, and is calculated under the same assumptions. 620×90%-8.76=550 mAH, which is well below the total battery capacity provided by the battery of the wireless transmitter unit 50. Accordingly, the inventive transmitter unit 50 has at least a ten-year operational life without needing to have the battery removed or replaced.

Accordingly, the present invention provides a wireless lighting device 10 that is a stand-alone design, having no interaction with the electrical system of a vehicle on which the device 10 is installed, thereby avoiding the problems of existing devices including short circuit and increased load on the electrical system of the vehicle. Furthermore, the wireless lighting device 10 is easy to install on a vehicle, whether that installation be at the time of the vehicle's manufacture or in an aftermarket context, thereby resulting in a lower installation cost. The wireless light device 10 additionally provides a unique and customizable feature for brands or for consumers. The device 10 enhances ambient lighting of a vehicle and also provides enhanced safety features. The coin batteries used in the inventive device 10 additionally provide a benefit that the batteries are easily available and do not pose a fire risk or liquid leakage problem. Furthermore, the particular design of the inventive device 10, with the selection of the particular batteries and the encapsulation of the light board 12 and the transmitter unit 50 ensures that the batteries maintain enough capacity to provide an operational life of at least ten years for the inventive wireless device 10 without the need for battery removal or replacement. The wireless nature of the inventive lighting device 10 ensures that there is no wiring needed for the device 10, meaning there is no need to dismantle the vehicle in order to install the device 10. This is a particularly appealing selling point for aftermarket users. Additionally, the inventive wireless lighting device 10 is compact and light weight, meaning that the light board 12 and the transmitting unit 50 maybe easily installed at various positions inside or outside of a vehicle. Furthermore, the inventive wireless lighting device 10 provides customization so that various words and/or designs may be displayed on the light board 12 based on a customer's particular preferences. Furthermore, the encapsulation of the light board 12 and the transmitter unit 50 of the inventive lighting device 10 provides the benefits of preventing the effects of environmental factors such as water, humidity, moisture, and extreme temperatures while also preventing human interference. By preventing a user from accessing the internal components of the various devices, the inventive device 10 is protected from human errors such as failing to replace the batteries correctly or at all.

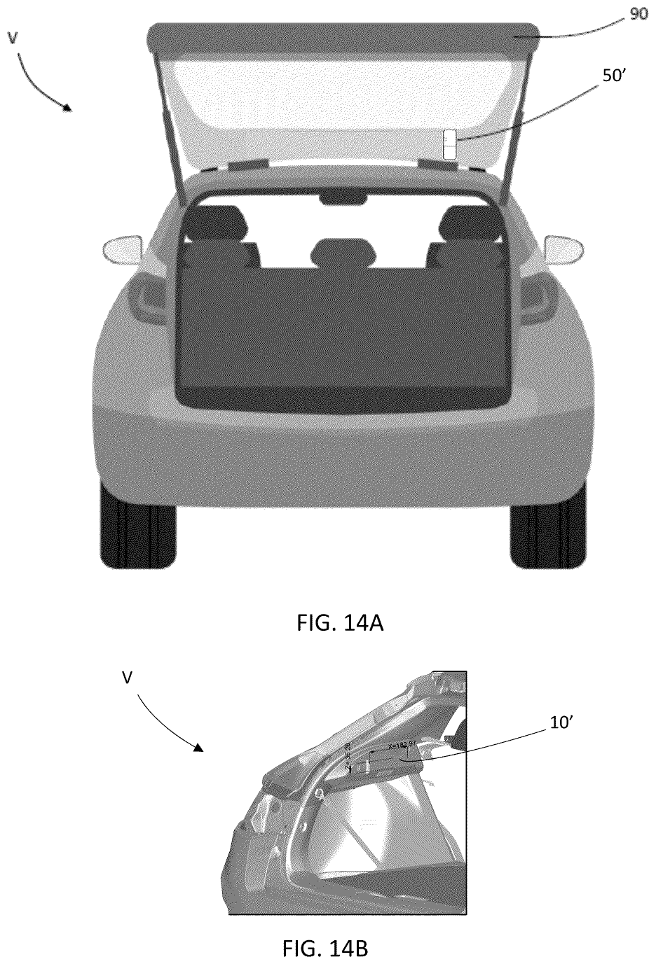

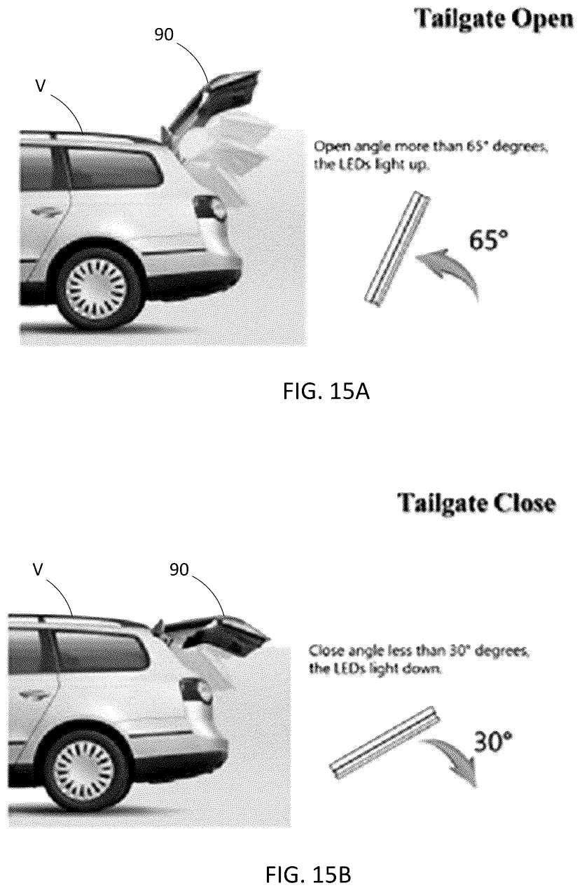

FIG. 14A is a rear view of a vehicle V having a transmitter unit device 50′ with an internal sensor configured for measurement of inclination mounted on a liftgate 90 thereof. The transmitter unit device 50′ is in wireless communication with an embodiment of a wireless lighting device 10′ positioned in the hatch or trunk area in proximity to the liftgate 90 of the vehicle V as shown in FIG. 14B. As will be explained further with respect to FIGS. 15A, 15B, 17, and 18 the interaction of the transmitter unit device 50′ with the wireless lighting device 10′ controls the on/off state of the lighting elements of the wireless lighting device 10′.

FIG. 15A is a side view of the vehicle of FIG. 14A with the liftgate moving toward an open position with an angle of inclination greater than an open threshold required to transmit a signal to turn on the wireless lighting device of FIG. 14B. In the example shown in FIG. 15A when the angle of inclination of the liftgate 90 exceeds sixty-five degrees a signal is transmitted from the transmitter unit device 50′ to the wireless lighting device 10′ to activate the lighting elements. Conversely as shown in the example of FIG. 15B, when the angle of inclination of the liftgate 90 is less than thirty degrees a signal is transmitted from the transmitter unit device 50′ to the wireless lighting device 10′ to deactivate the lighting elements. It is appreciated that the open and close thresholds for actuation of the lighting elements may be set by the user and/or the vehicle manufacturer.

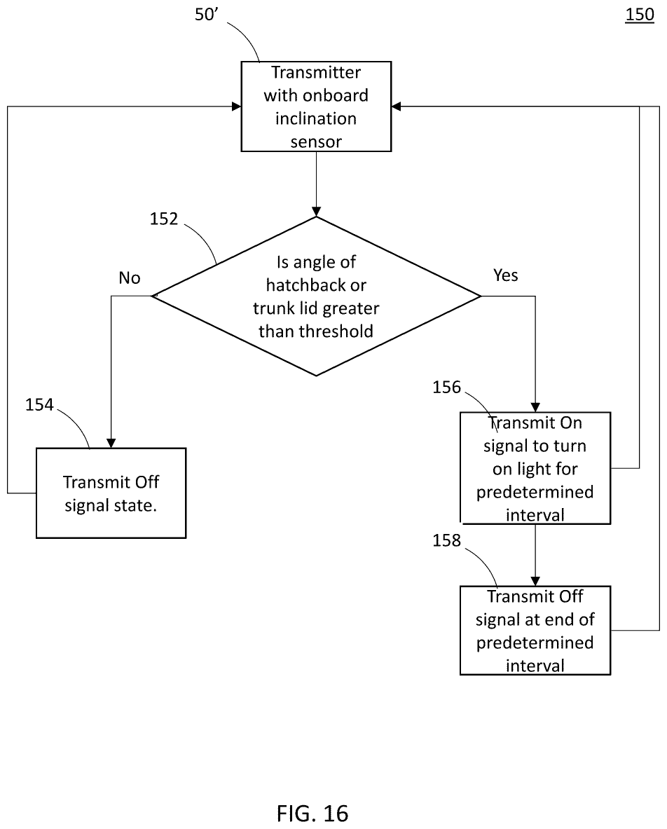

FIG. 16 is a flow diagram 150 of commands representative of software or firmware that control operation of the transmitter unit device 50′ of FIG. 14A. The sensor 17 of the transmitter unit device 50′ provides a signal to the software decision block 152 that determines if the inclination angle exceeds the threshold. If the inclination angle is below the threshold (Block 152 is No) a signal is not transmitted (Block 154) to the wireless lighting device 10′. If the inclination angle is above the threshold (Block 152 is Yes) a signal is transmitted to the wireless lighting device 10′ to activate the lighting elements (Block 156) for a predetermined interval (auto off) after which a transmit off signal is transmitted from the transmitter 50′ to the wireless lighting device 10′ to activate the lighting elements (Block 158). The software or firmware may be stored on a wireless system-on-chip (SOC) processor of the transmitter unit device 50′. In a specific embodiment the software of the transmitter unit device 50′ is addressable by the user to adjust threshold levels for actuation of the lighting elements.

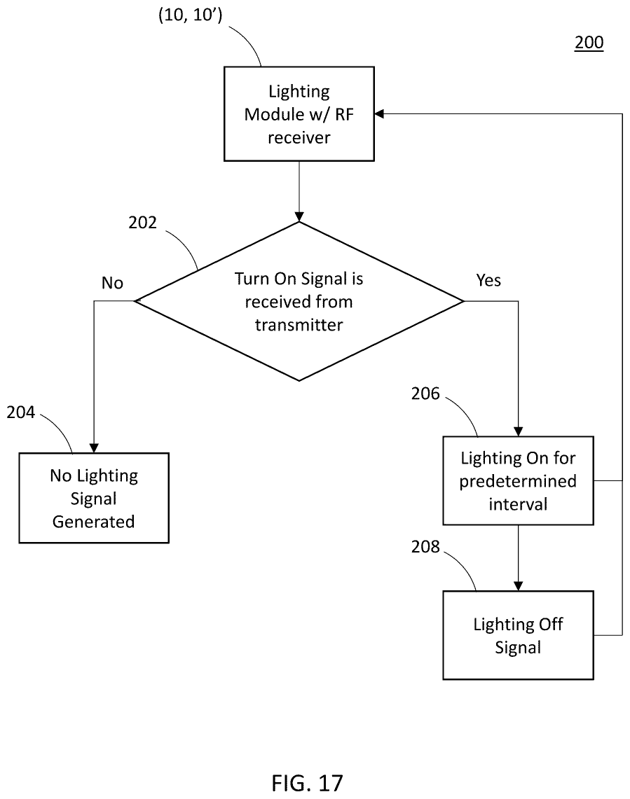

FIG. 17 is a flow diagram 200 of commands representative of software or firmware that control operation of the wireless lighting device 10′ of FIG. 14B as well as in specific embodiments the wireless lighting device 10. The receiver 17 of the wireless lighting device (10,10′) provides a signal to the software decision block 202 that determines if the lighting elements should be turned on in response to the inclination angle exceeding the threshold. If no signal is received from the transmitter (Block 202 is No) no lighting signal is generated (Block 204). If a signal is received from the transmitter (Block 202 is Yes) to the lighting elements of wireless lighting device (10, 10′) are activated (Block 206) for a predetermined interval (on-state, auto-off) after which the lighting elements are turned off (Block 208). It is appreciated that the on-interval is set so as to conserve battery power, where the amount of battery used is inversely proportional to length of time the lighting elements are lit on the wireless lighting device (10,10′). For example, if the lighting elements remain lit the entire time the trunk or liftgate is open the battery will not last as long as if there is a timed on-interval such as thirty seconds per opening event. The software or firmware may be stored on a wireless system-on-chip (SOC) processor of the wireless lighting device (10, 10′). In a specific embodiment the software of the wireless lighting device (10, 10′) is addressable by the user to adjust the on-time (auto-off) of the lighting elements.

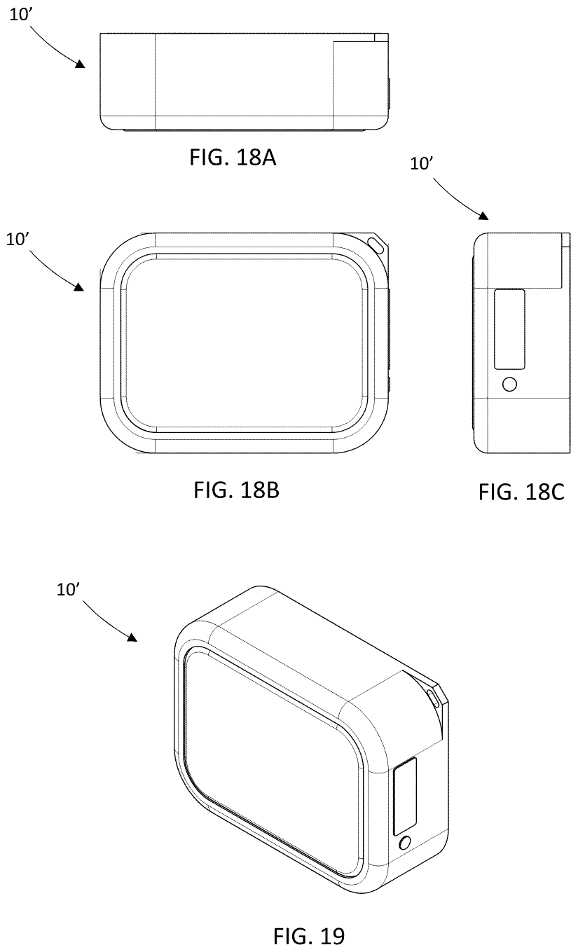

FIGS. 18A-18C are a top view, front view, and right side view, respectively, of the wireless lighting device 10′ of FIG. 14B. FIG. 19 is a perspective front view of the wireless lighting device 10′ of FIG. 14B.

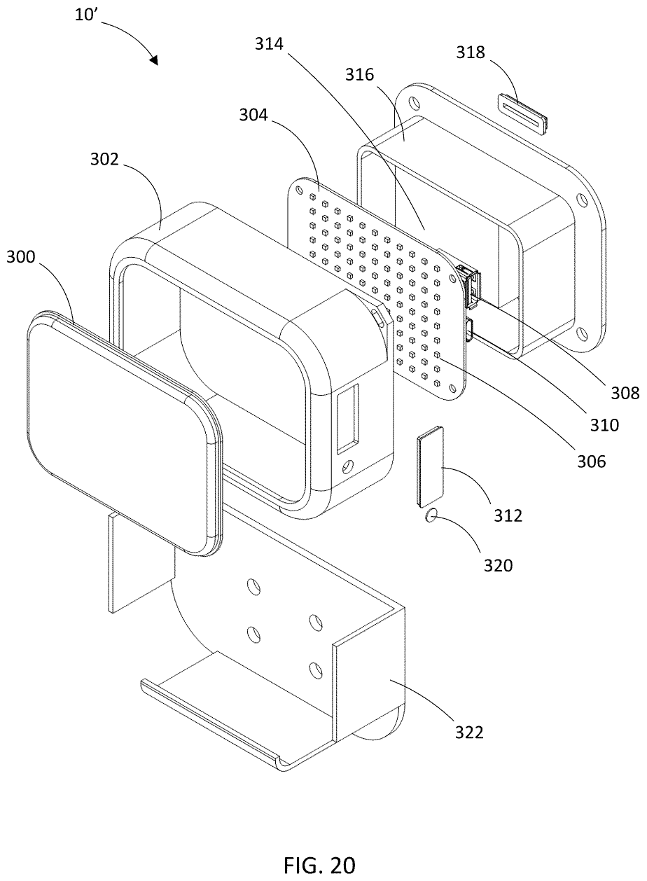

FIG. 20 is an exploded view of the wireless lighting device 10′ of FIG. 14B. The wireless lighting device 10′ has a lens 300 sealed to a cover housing 302. Within the cover housing 302 is a printed circuit board (PCB) 304 with a wireless system-on-chip (SOC) processor and an array of lighting elements in the form of light emitting diodes (LED) 306 on the front facing portion of the PCB 306. The PCB 306 further serves as a power distribution and data connection points for external connectors that illustratively include universal serial bus connectors (USB-A 308, USB-C 310). The USB connectors may serve as a data port as well as a charging port for a battery 316 which in specific embodiments is rechargeable. The USB connectors (308, 310) are covered with a removeable protection cover 312 that prevents moisture and dirt from collecting in the USB connectors (308, 310). The battery 314 is contained in a base 316 and is electrically connected to and covered by the PCB 304. The base 316 is fastened to the cover housing 302 to form a sealed enclosure. A battery charge level indicator 318 may also be provided. A manual on/off button 320 may be provided to control the light provided by the wireless lighting device 10′. A bracket 322 may be fastened to a portin of the vehicle V to hold the wireless lighting device 10′.

In a specific embodiment the transmitter unit device 50′ has the following specifications. The dimensions for the housing are 71.5 (L) mm×32.5 (W) mm×(6.5) (H) (including adhesive mounting tape) mm with a weight of 13 g (not including the single CR2430 battery). The battery has an expected life of up to two years based on a transmitting power consumption of 3 V and an active current draw of less than 15 mA. Standby power consumption is less than 8 uA. The on-board processor is a 2.4 GHz RF transceiver with an analog to digital (A/D) flash microcontroller unit (MCU). The sensor is a gravity-based G sensor.

In a specific embodiment the wireless lighting device 10′ has the following specifications. The dimensions for the housing are 105 (L) mm×80 (W) mm×(35) (H). The battery is a 10,000 mAH (18650×3) and is rechargeable. The on-board processor is a sub 1 GHz RF transceiver with an analog to digital (A/D) flash microcontroller unit (MCU, with a receiver operates in the 2.4 GHz band. The wireless lighting device 10′ has a water resistance rating of IPX7.

Referring again to FIGS. 1, 11, 12, and 14, the light board device 10 additionally includes a top cover 18, 18′, 18″ that is configured to cover the backlight module and batteries positioned within the housing 11 and to irreversibly seal to the baseplate 14, 14′, 14″, thereby encapsulating the backlight module 13 and the batteries 41 therein. Accordingly, it will be understood that the batteries 41 contained therein are not intended to be removable or replaceable. When the top cover 18, 18′, 18″ is sealed to the baseplate 14, 14′, 14″, the contents contained therein are protected from the environment and also protected from human interaction. The top cover 18, 18′, 18″ is arranged on the upper surface of the baseplate 14, 14′, 14″ and has at least one first light-permeable region 81 arranged above the backlight module 13 and allowing light to emit out. According to some inventive embodiments, the top cover 18, 18′, 18″ is stuck to the baseplate 14, 14′, 14″ with a waterproof glue or tape 82 so as to enhance the waterproof effect. In another inventive embodiment, the top cover 18, 18′, 18″ includes, but not limited to, a digitally printed inscription plate. According to other inventive embodiments, the inscription plate may be customized to have any letter, character, word, phrase, or pattern with any desired color.

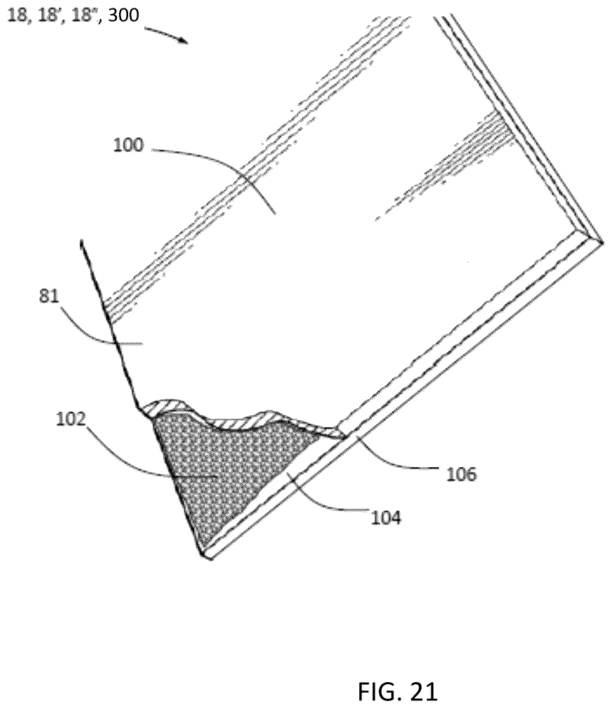

FIG. 21 is a partial cutaway view of the top cover 18, 18′, 18″ of the light permeable region 81 and of the lens 300 with a sandwich structure with a top layer 100 that encapsulates a dispersion of phosphorescent material 102 applied to an upper surface 104 of a bottom layer 106. The layers 100 and 106 are each independently formed with a transparent or translucent portion to transmit light generated therethrough. Glass or polycarbonate are suitable materials from which layers 100 and/or 106 are formed. The phosphorescent dispersion 102 forms a layer on the upper surface 104 of the bottom layer 106 by methods illustratively including applying a topcoat of phosphorescent material to the upper surface 104 or molding a polymeric sheet having phosphorescent material embedded therein.

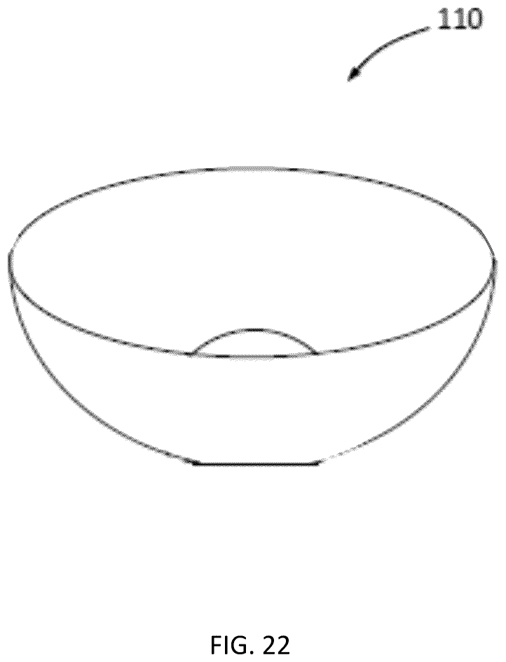

FIG. 22 illustrates a form of an optical reflector. The optical reflector may include a parabolic surface 110. In still other embodiments, the parabolic surface 110 has either a mirrored or white reflective coating.

In conclusion, the present invention proposes a novel wireless light board, which is slim, waterproof, power-saving, easy to install, convenient for battery replacement and can solve the problem of misalignment.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The embodiments have been described above to demonstrate the technical contents and characteristics of the present invention and enable the persons skilled in the art to understand, make, and use the present invention. However, these embodiments are not intended to limit the scope of the present invention. Contrarily, any equivalent modification or variation according to the spirit of the present invention would be also included within the scope of the claims of the present invention. The claims of the present invention should be interpreted in the broadest sense to cover all the equivalent modifications and variations.

The foregoing description is illustrative of particular embodiments of the invention but is not meant to be a limitation upon the practice thereof. The following claims, including all equivalents thereof, are intended to define the scope of the invention.

1. A wireless lighting device for vehicle accessories, the wireless lighting device comprising:
a housing having a baseplate and a top cover complementary to the baseplate, the housing having at least one light permeable region in the top cover to define an encapsulant and an internal volume therein;
a phosphorescent dispersion within the at least one light permeable region of the top cover or on an inner wall of the baseplate;
a backlight module configured to be accommodated within the internal volume of said housing, said backlight module comprising a circuit board, a plurality of light emitting elements having only visible light emissions or only visible light in combination with ultraviolet light, the plurality of light emitting elements adapted to provide both illumination visible to a normal human eye and also to excite the phosphorescent dispersion to emit light, a sensor configured to detect a signal, and a control module configured to turn the light emitting elements on and off according to the signal detected;
a transmitter unit comprising a radio frequency transmitter, a devoted transmitter battery, and an encapsulant containing and protecting the radio frequency transmitter and the devoted transmitter battery, the transmitter unit configured to transmit the signal perceptible by the sensor, the signal transmitted in response to a pre-selected motion; and
a power module including at least one battery and a conductive strip, the conductive strip extending from an end of the circuit board and configured to electrically connect the at least one battery to the circuit board and provide power to the sensor and said backlight module.

2. The wireless lighting device of claim 1 wherein the top cover is integrally formed as a unitary body.

3. The wireless lighting device of claim 1 wherein the top cover is configured to be irreversibly sealed to the baseplate.

4. The wireless lighting device of claim 1 wherein the sensor is one of a magnetic sensor or a gravity sensor.

5. (canceled)

6. The wireless lighting device of claim 1 wherein the transmitter unit is configured to be installed on a frame of a vehicle or on a door of a vehicle.

7. (canceled)

8. (canceled)

9. (canceled)

10. The wireless lighting device of claim 1 wherein the baseplate of said housing of said encapsulated light board defines at least one recess.

11. The wireless lighting device of claim 1 wherein the baseplate and the top cover of said housing of said encapsulated light board are formed as a tube.

12. The wireless lighting device of claim 1 wherein the plurality of light emitting elements are LEDs.

13. The wireless lighting device of claim 1 wherein said power module provide power for 10 years of vehicle usage without opening said encapsulated light board.

14. The wireless lighting device of claim 1 wherein the light board further comprises one or more optical reflector structures.

15. The wireless lighting device of claim 1 wherein the phosphorescent dispersion comprises phosphorescent inorganic particles or organic phosphorescent molecules.

16. The wireless lighting device of claim 1 wherein the phosphorescent dispersion is applied with a polymeric binder or adhesive to the top cover.

17. The wireless lighting device of claim 1 wherein the light permeable region of the top cover includes a customizable inscription.

18. The wireless lighting device of claim 1 wherein the encapsulated light board is configured to be installed in a vehicle door, a trunk lid, a vehicle liftgate, a vehicle tailgate, a vehicle door sill, a vehicle seat, and a vehicle floor mat.

19. The wireless lighting device of claim 1 wherein the at least one battery is rechargeable.

20. The wireless lighting device of claim 1 wherein the transmitter is configured to be installed on a trunk lid or vehicle liftgate and comprises a sensor that determines a level of inclination of the trunk lid or vehicle liftgate, and actuates the plurality of light emitting elements of the wireless lighting device based on a threshold of inclination via a transmitted signal.

21. The wireless lighting device of claim 1 wherein the transmitter unit further comprises a system on chip (SOC).

22. The wireless lighting device of claim 21 wherein the SOC is wireless.

23. The wireless lighting device of claim 1 wherein the transmitter unit further comprises a replaceable battery power source.

24. The wireless lighting device of claim 1 wherein the transmitter unit further comprises an internal sensor that measures inclination.
